(19) United States
(12) Patent Application Publication
(10) Pub. No.: US 2026/0261821 A1
(43) Pub. Date: Sep. 3, 2026

(54) NETWORK QUALITY RECOMMENDATION FOR NETWORK DELIVERED SERVICES

(71) Applicant: Telefonaktiebolaget LM Ericsson (publ), Stockholm (SE)

(72) Inventors: Miguel BERG, Sollentuna (SE); Niklas WERNERSSON, Kungsangen (SE); Markus RINGSTRÖM, Enebyberg (SE)

(21) Appl. No.: 19/163,245

(22) PCT Filed: Mar. 10, 2023
(86) PCT No.: PCT/EP2023/056226

§ 371 Date: Sep. 8, 2025

(51) Int. Cl. H04W 4/021

(52) U.S. Cl. CPC H04W 4/021

(57) ABSTRACT

Embodiments of the present disclosure provide a method (200) for improving access to a network delivered service. The method (200) is performed by a radio access network, RAN, node (104) comprising one or more network nodes. The method (200) comprises obtaining network quality information for a coverage area comprising locations of the plurality of UEs (102a-102n). The method (200) comprises determining, based on the network quality information, at least for the first UE (102a), a network quality related recommendation comprising information relating to a position within the coverage area for which the network quality information satisfies a service quality requirement associated with the network delivered service. The method comprises providing at least to the first UE (102a), the network quality related recommendation for accessing the network delivered service. Corresponding network node (104), and computer program products are also disclosed.

### TECHNICAL FIELD

The present disclosure relates generally to the field of network delivered services. More particularly, it relates to a method, network node and computer program products for improving access to a network delivered service.

### BACKGROUND

Generally, modern cellular systems, for example, 5G New Radio, NR, systems, can provide a wide variety of services (referred hereinafter as network delivered services) to a plurality of User Equipments, UEs. The network delivered services may include subscription based services. Each network delivered service may be associated with different service quality requirements.

In 3GPP radio access networks, RANs, a base station can include a RAN Node such as an Evolved Universal Terrestrial Radio Access Network, E-UTRAN and/or Radio Network Controller, RNC in an E-UTRAN, which communicates with the communication device, known as user equipment, UE. In fifth generation, 5G, wireless RANs, RAN Nodes can include a 5G Node e.g., 5G eNB or gNB. The RAN provides access to communication services through a core network.

The RAN in recent times has transformed from a traditional RAN to an open RAN, O-RAN. A core network may be connected to the UE through the RAN. The core network may include a serving gateway, SGW, a packet data network, PDN, gateway PGW, an access network detection and selection function, ANDSF, server, an enhanced packet data gateway, ePDG, and/or a mobility management entity, MME or the like.

The legacy way of providing the RAN is that there is a single entity and the internal interfaces within that entity are closed and are in hands of one vendor of the RAN. In the O-RAN, there exists a functional split between different functions of the RAN into the following entities namely a centralized unit, CU, a distributed unit, DU, and a radio unit, RU with open interfaces between them. A similar architecture is defined within 3GPP, but with the O-RAN approach, those entities can be developed by different vendors due to the open interfaces between the entities, including Open Fronthaul, Open FH. Therefore, the O-RAN includes Disaggregation of the RAN into the mentioned functions i.e., the CU, the DU, and the RU decoupling of software from hardware (virtualization), and opening of internal RAN interfaces.

Under good network conditions, i.e., when a signal-to-noise, SNR, ratio is high, the cellular systems can provide the network delivered services to the UEs with high throughput, while using high-order modulation scheme like, 256-Quadrature Amplitude Modulation, QAM. The 256-QAM with high code rate may be used to transmit many bits per resource element. Further, multi-user multi input and multi output, MU-MIMO, can be used to provide the network delivered services to the UEs. Using MU-MIMO, it is possible to simultaneously use a same time/frequency resource to support many simultaneous UEs if beams to/from UEs are clearly separated in an angle. In some instances, it is also possible to reuse the same resource to multiple users even if beams are not clearly separated in the angle (i.e., if wanted signals can be made to add constructively, and unwanted signals add destructively, in the respective receivers).

However, factors such as, path loss, shadow fading, insufficient spatial separation between the UEs, and interference caused by the other UEs or network nodes in a communication system or by the other communication systems can degrade the throughput of the UEs and/or cells by reducing SNR and a number of UEs that can be separated by MU-MIMO. As a result, only fewer numbers of UEs may be served with the network delivered services or there may be degradation in the service quality requirements associated with the network delivered services.

### SUMMARY

Consequently, there is a need for a method for improving access to the network delivered service that alleviates at least some of the above cited problems.

It is therefore an object of the present disclosure to provide a method, a network node, and a computer program product for improving access to a network delivered service to mitigate, alleviate, or eliminate all or at least some of the above-discussed drawbacks of presently known solutions.

This and other objects are achieved by means of a method, a network node, and a computer program product as defined in the appended claims. The term exemplary is in the present context to be understood as serving as an instance, example or illustration.

According to a first aspect of the present disclosure, a method for improving access to a network delivered service is provided. The method is performed by a radio access network, RAN, node comprising one or more network nodes that represent the RAN node. The method comprises obtaining network quality information for a coverage area comprising locations of the plurality of UEs. The method comprises determining, based on the network quality information, at least for the first UE, a network quality related recommendation comprising information relating to a position within the coverage area for which the network quality information satisfies a service quality requirement associated with the network delivered service. The method comprises providing at least to the first UE, the network quality related recommendation for accessing the network delivered service.

In some examples, the one or more network nodes of the RAN node include a first network node which is a distributed unit, DU, which may also be a first user plane node or a first control plane node. Further, the one or more network nodes may include a second node which is a radio unit, RU, which may also be a second user plane node or a second control plane node. The first node and the second node are the functions within a radio access network, RAN, or the network node.

In some examples, the method can also be performed by a network node which is not in communication with the plurality of UEs, however, it is required that the network node obtains network quality information from any other network node that is in communication with the UEs.

The method may be performed in different network nodes, e.g., the first network node as described above determines the recommendation based on the network quality information obtained by a second node, and a third network node provides the information to the UEs. These network nodes (physical or virtual) may be provided by different network vendors.

In some examples, the method may be performed by one or more network entities residing in a cloud.

In some examples “position” and “location” may include different things, e.g., absolute, relative to another UE, or relative to some other object.

The network quality related recommendation is provided to at least for the first UE among the plurality of UEs for improving access to the network delivered service. When the first UE accesses the network delivered service at the recommended position, one or more of the following advantages are achieved.
at least the first UE may be moved away from a blocking object in a signal path/communication path established between the first UE and the network node;
at least the first UE may be moved to a position with improved signal strength of the communication link to a network node;
an interference to the first UE from any another network node/cell may be reduced;
the spatial separation between at least the first UE and another UE may be increased;
signal strength and performance of the first UE may be improved while meeting the service quality requirements associated with the network delivered service;
throughput and/or latency of at least the first UE, and throughput of the network node/cell may be improved; and
   user experience of accessing the network delivered service may be enhanced

In some embodiments, the step of determining the network quality related recommendation at least for the first UE comprises determining a position within the coverage area at least for the first UE and/or determining a direction and optionally a distance to move within the coverage area at least for the first UE.

The network quality related recommendation comprising the information relating to the position within the coverage area may be determined for at least the first UE among the plurality of UEs based on a mapping of the network quality information, the network delivered service related requirements, and results of checking whether the at least one position within the coverage area satisfies the service quality requirements associated with the network delivered service. As a result, access to the network delivered service may be improved at the recommended position.

In some embodiments, the step of obtaining the network quality information comprises determining whether a recommendation request message is received from one or more of: at least the first UE and an application being executed on the first UE for accessing the network delivered service. When it has been determined that the recommendation request message is received, the method comprises obtaining the network quality information.

In some embodiments, the step of obtaining the network quality information further comprises retrieving, from a database or from a model, signal quality for the coverage area. The model is based on one or more of artificial intelligence, AI, digital twin, or machine learning, ML. The network quality information may be predicted from the model. In some examples, signal quality information from the UEs can be obtained using “Minimization of Drive Test (MDT)” feature according to 3GPP TS 37.320.

In some examples, there may be a plurality of UEs present within the coverage area for which the signal quality is determined. In another example, the signal quality or network quality is obtained for the coverage area where there are no UEs present at a time interval. In some embodiments, the network quality information comprises one or more of: radio coverage characteristics of the network node, performance characteristics of the network node, propagation properties of a radio channel established between the network node and the plurality of UEs and one or more scheduling schemes related to the network delivered service to the plurality of UEs.

In some embodiments, the step of determining the network quality related recommendation comprising information relating to the position within the coverage area comprises obtaining network delivered service related information from at least the first UE within the coverage area. The method comprises identifying at least one position within the area for the network quality related recommendation based on the network delivered service related information. The method comprises obtaining the network quality information for the identified at least one position. The method comprises determining whether the network quality information for the identified at least one position satisfies the service quality requirement associated with the network delivered service. When it has been determined that the network quality information for the at least one identified position satisfies the service quality requirement associated with the network delivered service, the method comprises identifying position information for the network quality related recommendation.

In some embodiments, the network delivered service related information comprises one or more of: at least one application being executed on the first UE and radio resources required for the at least one application being executed on the first UE.

In some embodiments, the step of providing to at least the first UE, the network quality related recommendation for accessing the network delivered service comprises recommending information related to the position through one or more of: an application being executed on the first UE and a short messaging service, SMS.

In some embodiments, the step of providing to at least the first UE, the network quality related recommendation for accessing the network delivered service comprises determining whether the first UE has been subscribed for receiving the network quality related recommendation comprising information related to the position. When it has been determined that the first UE has been subscribed for receiving the recommendation, the method comprises recommending to at least the first UE, the network quality related recommendation for accessing the network delivered service.

In some embodiments, the network delivered service is a subscription based service comprising one or more of: a data service, a voice service, a multimedia broadcast multicast service, MBMS, and over-the-top, OTT service.

According to a second aspect of the present disclosure, an apparatus of a network node configured to improve access to a network delivered service is provided. The network node is in communication with a plurality of User Equipments, UEs, including a first UE. The apparatus comprises a controlling circuitry. The controlling circuity is configured to cause obtaining of network quality information for a coverage area. The controlling circuitry is configured to cause determination of, based on the network quality information, at least for the first UE, a network quality related recommendation comprising information relating to a position within the coverage area for which the network quality information satisfies a service quality requirement associated with the network delivered service. The method comprises providing of, at least to the first UE, the network quality related recommendation for accessing the network delivered service.

A third aspect is a network node comprising the apparatus of the second aspect.

According to a fourth aspect of the present disclosure, there is provided a computer program product comprising a non-transitory computer readable medium, having thereon a computer program comprising program instructions. The computer program is loadable into a data processing unit and configured to cause execution of the method according to the first aspect when the computer program is run by the data processing unit

In some embodiments, any of the above aspects may additionally have features identical with or corresponding to any of the various features as explained above for any of the other aspects.

An advantage of some embodiments is that alternative and/or improved approaches are provided for improving access to the network delivered service.

An advantage of some embodiments is that by providing the network quality related recommendation, an angular separation of the plurality of UEs in view of the network node may be increased by allowing more multi-user multi input multi output, MU-MIMO layers by having the UEs in clearly separated beams.

Other advantages may be readily apparent to one having skill in the art. Certain embodiments may have none, some, or all of the recited advantages.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIGS. 1a and 1b disclose a wireless communication system according to some examples;

FIG. 2 is a flowchart illustrating example method steps according to some examples;

FIG. 3 is a flowchart illustrating example method steps according to some examples;

FIG. 4 is a schematic block diagram illustrating an example apparatus according to some examples;

FIG. 5 is a block diagram of a telecommunication network connected via an intermediate network to a host computer, according to some examples;

FIG. 6 is a block diagram of a host computer communicating via a base station with a user equipment, UE, over a partially wireless connection, according to some examples;

FIG. 7 is a block diagram of methods implemented in a communication system including a host computer, a base station, and a UE, according to some examples;

FIG. 8 is a block diagram of methods implemented in a communication system including a host computer, a base station, and a UE, according to some examples;

FIG. 9 is a block diagram of methods implemented in a communication system including a host computer, a base station, and a UE, according to some examples;

FIG. 10 is a block diagram of methods implemented in a communication system including a host computer, a base station, and a UE, according to some examples; and

FIG. 11 discloses an example computing environment.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

In some embodiments, a more general term “network node” may be used and may correspond to any type of radio access network, RAN, node or any network node, which communicates with a user equipment, UE, (directly or via another node) and/or with another network node. For example, the RAN node consists of multiple network nodes such as Open Radio Access Network, O-RAN, node comprising functional units such as O-RAN Distributed unit, O-DU, O-RAN Central Unit, O-CU and O-RAN Radio Unit, O-RU, Service Management and Orchestration, SMO, Near Real-Time Radio Intelligent Controller (RIC), Non Real-Time RIC and so on.

In 3GPP radio access networks, RANs, in LTE systems, a base station can include a RAN Node such as an Evolved Universal Terrestrial Radio Access Network, E-UTRAN and/or Radio Network Controller, RNC in an E-UTRAN, which communicates with the communication device, known as user equipment, UE. In fifth generation, 5G, wireless RANs, RAN Nodes can include a 5G Node e.g., En-gNB or gNB. The RAN provides access to communication services through a core network.

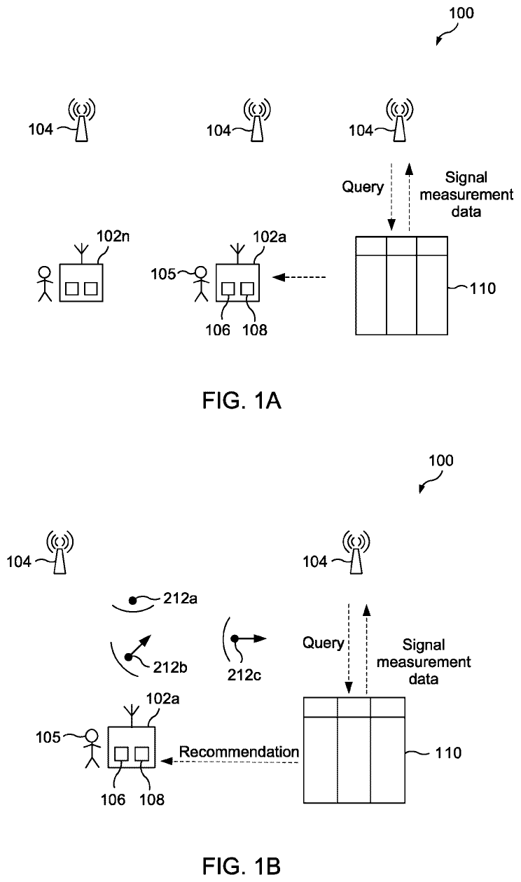

The RAN in recent times has transformed from a traditional RAN to an open RAN, O-RAN as shown in FIG. 1A. A core network 106 may be connected to the UE 108 through the RAN. The core network 106 may include a serving gateway, SGW, a packet data network, PDN, gateway PGW, an access network detection and selection function, ANDSF, server, an enhanced packet data gateway, ePDG, and/or a mobility management entity, MME or the like.

The legacy way of providing the RAN is that there is a single entity and the internal interfaces within that box are closed and are in hands of one vendor of the RAN. In the O-RAN, there exists a functional split between different functions of the RAN into the following entities namely a centralized unit, CU 101, a distributed unit, DU 102, and a radio unit, RU 104 with open interfaces between them. A similar architecture is defined within 3GPP, but with the O-RAN approach, those entities can be developed by different vendors due to the open interfaces between the entities, including Open Fronthaul, Open FH. Therefore, the O-RAN includes Disaggregation of the RAN into the mentioned functions i.e., the CU 101, the DU 102, and the RU 104, decoupling of software from hardware (virtualization), and opening of internal RAN interfaces.

In some examples, the RAN node may be a NodeB, a MeNB, a ENB, a network node belonging to a master cell group, MCG, or a secondary cell group, SCG, a base station, BS, and a multi-standard radio, MSR, a radio node such as a MSR BS, an eNodeB, a gNodeB, a network controller, a radio network controller, RNC, a base station controller, BSC, a relay, a donor node controlling relay, a base transceiver station, BTS, access points, APs, transmission points, transmission nodes, a remote radio unit, RRU, and a remote radio head, RRH, nodes in distributed antenna system, DAS, a core network node (for example, a mobile switching center, MSC, a mobility management entity, MME, or the like), an operation & management, O&M, node, an operations support system, OSS, node a self-optimized network, SON, a positioning node (for example, an evolved serving mobile location center, E-SMLC), a minimization drive test, MDT, test equipment (for example, a physical node or software), and so on.

In some embodiments, a non-limiting term user equipment, UE, or a wireless device may be used and may refer to any type of wireless device communicating with a network node and/or with another UE in a wireless communication system. Examples of the UE are a target device, a device to device, D2D, UE, a machine type UE, a UE capable of machine to machine, M2M, communication, personal digital assistant, PDA, tablet, mobile terminals, smart phone, laptop embedded equipped, LEE, laptop mounted equipment, LME, universal serial bus, USB, dongles, UE category M2, ProSe UE, vehicle-to-vehicle, V2V, UE, vehicle-to-everything, V2X UE, and so on.

Additionally, terminologies such as base station/gNodeB, and UE should be considered non-limiting and do in particular not imply a certain hierarchical relation between the two; in general,“gNodeB” could be considered as device 1 and “UE” could be considered as device 2 and these two devices communicate with each other over some radio channel. In the following the transmitter or receiver could be either gNB, or UE.

Embodiments of the present disclosure will be described and exemplified more fully hereinafter with reference to the accompanying drawings. The solutions disclosed herein can, however, be realized in many different forms and should not be construed as being limited to the embodiments set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

In the following description of exemplary embodiments, the same reference numerals denote the same or similar components.

FIGS. 1A and 1B disclose an example wireless communication system 100. Although the subject matter described herein may be implemented in any appropriate type of system using any suitable components, the embodiments disclosed herein are described in related to a wireless communication system/wireless network, such as the example wireless communication system 100 depicted in FIGS. 1A and 1B. The wireless communication system 100 may comprise and/or interface with any type of communication, telecommunication, data, cellular, and/or radio network or other similar type of system. In some embodiments, the wireless communication system 100 may be configured to operate according to specific standards or other types of predefined rules of procedures. Thus, particular embodiments of the wireless communication system 100 may implement communication standards, such as, but are not limited to, global system for mobile communications, GSM, universal mobile telecommunications system, UMTS, long term evolution, LTE, and/or other suitable 2G, 3G, 4G, or 5G standards, wireless local area network, WLAN, standards such as, IEEE 802.11 standards, and/or any other appropriate wireless communication standards, such as, worldwide interoperability for microwave access, WiMax, Bluetooth, Z-Wave and/or ZigBee standards. The wireless communication system 100 may provide communication and other type of services to one or more wireless devices to facilitate the wireless devices' access to and/or use of the services provided by, or via, the wireless communication system 100.

For simplicity, as depicted in FIGS. 1A and 1B, the wireless communication system 100 comprises a plurality of network nodes 104 and a plurality of User Equipments, UEs, 102a-102n. The network nodes 104 and the UEs 102a-102n operate together in order to provide wireless connections in the wireless communication system 100. In practice, the wireless communication system 100 may further include any additional elements suitable to support communication between wireless devices or between a wireless device and another communication device, such as a landline telephone, a service provider, or any other network node or end device. In different embodiments, the wireless communication system 100 may comprise any number of wired or wireless networks, network nodes, base stations, controllers, wireless devices, relay stations, and/or any other components or systems that may facilitate or participate in the communication of data and/or signals whether via wired or wireless connections.

The network node 104 refers to equipment capable, configured, arranged, and/or operable to communicate directly or indirectly with the plurality of UEs 102a-102n and/or with other network nodes or equipment in the wireless communication system 100 to enable and/or provide wireless access to at least one of the plurality of UEs 102a-102n and/or to perform other functions (for example, administration) in the wireless communication system 100. Examples of the network node 104 may include, but are not limited to, access points, APs (for example, radio access points), base stations, BSs (for example, radio base stations, nodeBs, evolved NodeBs, eNBs, new radio, NR, nodes (gNBs), or the like). The BSs may be categorized based on an amount of coverage the BSs provide (or, stated different, their transmit power level) and may then also be referred to as femto BSs, pico BSs, micro BSs, macro BSs. The BS may be a relay node or a relay donor node controlling a relay.

In some other examples, the network node 104 may also include one or more (or all) parts of a distributed radio base station such as centralized digital units and/or remote radio units, RRUs, sometimes referred to as remote radio heads, RRHs. Such remote radio units may or may not be integrated with an antenna as an antenna integrated radio. Parts of a distributed radio base station may also be referred to as nodes in a distributed antenna system, DAS.

In some other examples, the network node 104 may also include multi-standard radio, MSR, equipment such as, MSR BSs, network controllers such as radio network controllers, RNCs, or base station controller, BSCs, base transceiver stations, BTSs, transmission points, transmission nodes, multi-cell/multicast coordination entities, MCEs, core network nodes (for example, mobile switching centres, MSCs, mobility management entities, MMEs, or the like), operation & management, O&M, nodes, operations support system, OSS, nodes, self-organizing network, SON, nodes, positioning nodes (for example, E-SMLCs) and/or minimization drive test, MDT, test equipment.

In some other examples, the network node 104 may be a non-real time Radio Network, RAN, Intelligent controller, RIC, executing an R-app. In some other examples, the network node 104 may be a near real-time RIC in an Open RAN context. In some other examples, the network node 104 may include a node deployed in a computer cloud.

More generally, the network node 104 may represent any suitable device (or group of devices) capable, configured, arranged, and/or operable to enable and/or provide the at least one of the plurality of UEs 102a-102n with access to the wireless communication system 100.

In some examples, the network node 104 may provide communication services to the at least one of the plurality of UEs 102a-102n that has accessed the wireless communication system 100. In embodiments disclosed herein, the communication service may referred as network delivered service. In some examples, the network delivered service referred herein may be a subscription based service comprising one or more of: a data service, a voice service, a multimedia broadcast multicast service, MBMS, and over-the-top, OTT service. Each network delivered service may be associated with different service quality requirements such as, but are not limited to, latency, throughput, and so on.

A UE of the plurality of UEs 102a-102n, for example, a UE 102a, may refer to a device capable, configured, arranged and/or operable to communicate wirelessly with network nodes and/or other wireless devices. Unless otherwise noted, the term “wireless device” may be used interchangeably herein with the UE. Communicating wirelessly may involve transmitting and/or receiving wireless signals using electromagnetic waves, radio waves, infrared waves, and/or other types of signals suitable for conveying information through air.

Examples of the UE 102a may include, but are not limited to, a smart phone, a mobile phone, a cell phone, a voice over Internet Protocol, IP, VoIP, phone, a wireless local loop phone, a desktop computer, a personal digital assistant, PDA, a wireless camera, a gaming console or device, a music storage device, a playback appliance, a wearable terminal device, a wireless endpoint, a mobile station, a tablet, a laptop, a laptop-embedded equipment, LEE, a laptop-mounted equipment, LME, a smart device, a wireless customer-premise equipment, CPE, a vehicle-mounted wireless terminal device, and so on.

In some examples, the UE 102a may support device-to-device, D2D, communication, for example by implementing a 3GPP standard for side link communication, vehicle-to-vehicle, V2V, vehicle-to-infrastructure, V2I, vehicle-to-everything, V2X, and may in this case be referred to as a D2D communication device. In some other examples, in an Internet of Things, IoT, scenario, the UE 102a may represent a machine or other device that performs monitoring and/or measurements and transmits results of such monitoring and/or measurements to another wireless device and/or the network node 104. The UE 102a may in this case be a machine-to-machine, M2M device, which may in a 3GPP context be referred to as an MTC device. In some other examples, the UE 102a may be a UE implementing 3GPP narrow band IoT, NB-IoT, standard. Particular examples of such machines or devices are personal wearables (for example, watches, fitness trackers, or the like). In some other examples, the UE 102a may represent an equipment that is capable of monitoring and/or reporting on its operational status or other functions associated with its operation. The UE 102a as described above may represent the endpoint of a wireless connection, in which case the device may be referred to as a wireless terminal. Furthermore, a wireless device as described above may be mobile, in which case it may also be referred to as a mobile device or a mobile terminal.

In some examples, the UE 102a and the network node 104 may support multi user multi input and multi output. MU-MIMO allows a number of data streams available to be shared by the UE 102a.

In some examples, the UE 102a may comprise components such as a controller 106, a user interface, UI, module, 108 or the like. The controller 106 may be configured to execute one or more applications to access the network delivered services from the network node 104. The UI module 108 may be configured to enable a user, for example, a user 105, to interact with the UE 102a for accessing the network delivered services. As would be understood, the components such as the controller 106, and the UI module 108 may be configured to perform functionalities of the UE 102a disclosed in embodiments herein.

In some examples, in the wireless communication system 100, factors such as, but are not limited to, path loss, shadow fading, insufficient spatial separation between the UEs 102a-102n, interference caused by other UEs in the wireless communication system 100 or by other wireless communication systems, and so on, may degrade throughput of the UEs 102a-102n and the network node 104/cell by reducing signal to noise ratio, SNR, and a number of UEs that can be separated using MU-MIMO. In such a scenario, only fewer number of UEs 102a-102n may be served with the network delivered services or the necessary service quality requirements of the network delivered services may not be offered/guaranteed. As a result, the applications used by the UEs 102a-102n for accessing such network delivered services may start to experience abrupt disruptions in availability of the network delivered service when the network node 104 is not able to provide the necessary service quality requirements guarantees. The abrupt disruptions may degrade user experience and may lead to the reduced demand of such applications used to access the network delivered services.

Therefore, according to embodiments disclosed herein, the network node 104 implements a method capable of improving access to the network delivered service. It should be noted that the method disclosed herein may also be implemented by any of the UEs (102a-102n) to improve access to the network delivered service.

The network node 104 obtains signal quality information for a coverage area comprising locations of the plurality of UEs 102a-102n. The coverage area referred herein may be a region served by the network node 104.

For obtaining the network quality information, the network node 104 retrieves, from a database 110 or a model, signal quality data associated with the plurality of UEs 102a-102n for the coverage area by querying the database 110 or from the model. The model is based on one or more of artificial intelligence, AI, digital twin, or machine learning, ML. The network quality information may be predicted from the model. In some examples, the database 110 may be constructed from the signal measurement data stored in any of the UEs 102a-102n, and/or the signal measurement data reported by any of the UEs 102a-102n to the network node 104. In some examples, signal quality information from the UEs can be obtained using “Minimization of Drive Test (MDT)” feature according to 3GPP TS 37.320. With the MDT, time-stamped radio measurements along with UE location information can be obtained. In some examples, the model may be dedicated to collect the signal measurement data from the coverage area of the network node 104. Optionally, the network node 104 may also obtain the signal quality measured by the network node 104.

In other examples, the network quality information can be derived using a model that is not AI based. For example, a digital twin of the network can use a 3D-map with terrain and building data, and determines wireless signal propagation e.g., using ray-tracing techniques for different UE positions (either the current positions of actual UEs, or speculative for positions where UEs may be expected). The digital twin can estimate performance based on the positions of the UEs.

Based on the network quality information, the network node 104 determines at least for the first UE of the plurality of UEs 102a-102n, for example, the UE 102a, a network quality related recommendation. The network quality related recommendation comprises information relating to a position within the coverage area for which the network quality information satisfies a service quality requirement associated with the network delivered service. In some examples “a position” may include different things, e.g., absolute, relative to another UE, or relative to some other object.

In some embodiments, the determination of the network quality related recommendation at least for the first UE 102a may comprise determining the position within the coverage area at least for the first UE 102a and/or determining a direction and optionally a distance to move within the coverage area at least for the first UE 102a. Exemplary directions 212a-212c determined for the first UE 102a to move within the coverage area are depicted in FIG. 1B.

Upon determination, the network node 104 provides at least to the first UE 102a, the network quality related recommendation for accessing the network delivered service.

Various embodiments for improving access to the network delivered service are explained in conjunction with figures in the later parts of the description.

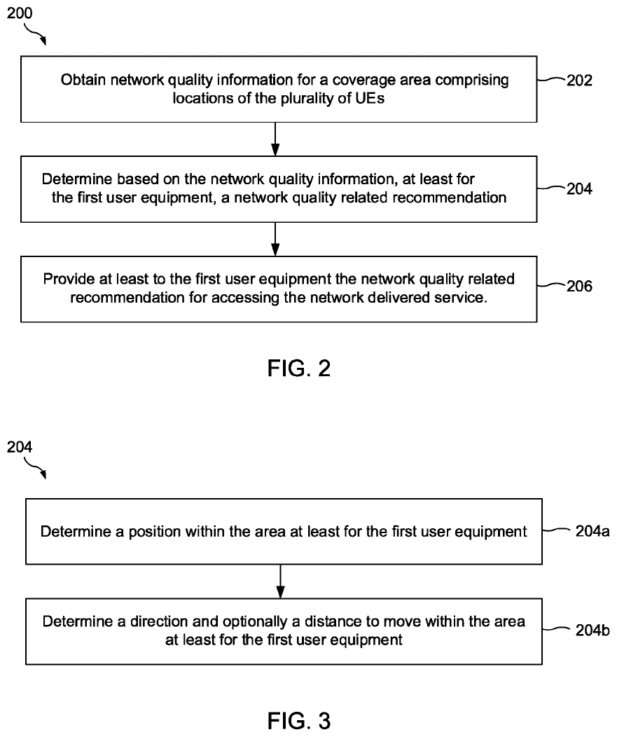

FIG. 2 is a flowchart illustrating example method steps of a method 200 performed by the network node to improve access to a network delivered service. In some examples, the network delivered service may be a subscription-based service comprising one or more of: a data service, a voice service, a multimedia broadcast multicast service, MBMS, and an over-the-top, OTT, service. It is to be noted that the network node may be a RAN node comprising one or more network nodes that represent the RAN node.

The legacy way of providing the RAN is that there is a single entity and the internal interfaces within that entity are closed and are in hands of one vendor of the RAN. In the O-RAN, there exists a functional split between different functions of the RAN into the following entities namely a centralized unit, CU, a distributed unit, DU, and a radio unit, RU with open interfaces between them. A similar architecture is defined within 3GPP, but with the O-RAN approach, those entities can be developed by different vendors due to the open interfaces between the entities, including Open Fronthaul, Open FH.

In some examples, the one or more network nodes of the RAN node include a first network node which is a distributed unit, DU, which may also be a first user plane node or a first control plane node. Further, the one or more network nodes may include a second node which is a radio unit, RU, which may also be a second user plane node or a second control plane node. The first node and the second node are the functions within a radio access network, RAN, or the network node.

In some examples, the method 200 can also be performed by a network node which is not in communication with the plurality of UEs, however, it is required that the network node obtains network quality information from any other network node that is in communication with the UEs.

In some embodiments, the method 200 may be performed in different network nodes, e.g., the first network node determines the recommendation based on the network quality information obtained by a second node, and a third network node provides the information to the UEs. These network nodes (physical or virtual) may be provided by different network vendors.

At step 202, the method 200 comprises obtaining network quality information for a coverage area comprising locations of the plurality of UEs. In some examples, the locations of the plurality of UEs may be considered in order to find ways to increase angular separation of the plurality of UEs in view of the network node. In some examples, the plurality of UEs may be present within the coverage area for which the network quality information is obtained. In another example, the signal quality or network quality is obtained for the coverage area where there are no UEs present at a time interval.

In some embodiments, the step of obtaining the network quality information may comprise determining whether a recommendation request message is received from one or more of: at least the first UE among the plurality of UEs, and an application being executed on the first UE for accessing the network delivered service. When it has been determined that the recommendation request message is received, the method may comprise obtaining the network quality information. Thus, the network quality information may be obtained on demand that is when a trigger is initiated by at least the first UE, or the application being executed on the first UE. As would be understood, in some examples, the network quality information may also be obtained based on a trigger initiated by the network node. In some examples, the network quality information may also be obtained based on a regular basis.

In some embodiments, the step of obtaining the network quality information may comprise retrieving, from the database or from the model, signal quality associated with the plurality of UEs for the coverage area. The model is based on one or more of artificial intelligence, AI, digital twin, or machine learning, ML. In some examples, the database may be constructed using the signal measurement data stored in at least the first UE, or maintained by the network node. In some examples, the model may be implemented to collect the signal measurement data from the coverage area of the network node. In some examples, the signal measurement data retrieved from the model may comprise a digital twin of the network node.

Optionally, the method may comprise obtaining signal quality performed by the network node. In some examples, the signal quality performed by the network node may comprise uplink measurements performed by the network node.

In some examples, the obtained signal measurement data may be considered as a function of the locations of the UEs. In some examples, the obtained signal measurement data may be considered as a function of a load of the network node.

Based on the signal measurement data, the method may comprise determining the network quality information. In some examples, the network quality information may comprise one or more of: radio coverage characteristics of the network node, performance characteristics of the network node, propagation properties of a radio channel established between the network node and the plurality of UEs, and one or more scheduling schemes related to the network delivered service to the plurality of UEs. In some examples, the performance characteristics of the network node may indicate one or more of: reliability, latency, throughput, or the like, of the network node.

It should be noted that in some examples, the network quality information may be determined through analysis of historical signal quality stored in the database. In some other examples, the network quality information may be determined using an artificial intelligence, AI, model. In some examples, the AI model may also include, but are not limited to, a neural network model, a machine learning model, a multi-class support vector machine, SVM, model, a recurrent neural network, RNN, model, a restricted Boltzmann machine, RBM, model, a deep belief network, DBN, model, a generative adversarial network, GAN, model, a regression based neural network model, a deep reinforcement model, a deep Q-network model, and so on.

Based on the network quality information, at step 204, the method 200 comprises determining, at least for the first UE, a network quality related recommendation comprising information related to a position within the coverage area for which the network quality information satisfies a service quality requirement associated with the network delivered service. The position referred herein may be a specific spot or region within the coverage area of the network node. In some examples, the service quality requirement associated with the network delivered service may comprise one or more of: latency, throughput, reliability, and so on.

In some examples, the network quality related recommendation may be determined based on a trigger initiated by at least the first UE, the application being executed on at least the first UE, performance indicators, input information received from the network node. In some examples, the performance indicators include throughput, latency, ‘perceived quality’, or a compound performance metric (which is compared with a per service required level of the compound performance metric). The compound performance metric comprises throughput and latency. The input information received from the network node may include information related to one or more of: beamforming methods, a UE pairing method, or the like, used by the network node while providing the network delivered service to the plurality of UEs.

In some embodiments, the step of determining network quality related recommendation may comprise obtaining network delivered service related information from at least the first UE within the coverage area. In some examples, the network delivered service related information may comprise one or more of: at least one application being executed on the first UE and radio resources required for the at least one application being executed on the first UE. For example, an application being used for accessing Extended Reality, XR, services may require/demand more radio resources than an application being used for accessing a music streaming service.

Based on the obtained network delivered service related information, the method may comprise identifying at least one position within the coverage area for the network quality related recommendation. In some examples, the at least one position may be identified using positioning methods such as, but are not limited to, Global Positioning System, GPS, Global navigation satellite system, GNSS, or the like. In other examples, the at least one position may also be identified by the cellular system, e.g., by Uplink Time-Difference of Arrival, UTDoA.

The method may comprise obtaining the network quality information for the identified at least one position. Upon obtaining the network quality information, the method may comprise determining whether the network quality information for the identified at least one position satisfies the service quality requirement associated with the network delivered service. When it has been determined that the network quality information for the at least one identified position satisfies the service quality requirement associated with the network delivered service, the method may comprise identifying position information for the network quality related recommendation. In some examples, the position information may comprise information about the position at which at least the first UE may access the network delivered service while satisfying the service quality requirement associated with the network delivered service. In some examples, the position information may comprise information about a direction and optionally a distance to move within the coverage area at least for the first UE to reach the recommended position. Step 204 is described in detail in conjunction with FIG. 3.

Thus, the network quality related recommendation may be determined based on a mapping of the network quality information, the network delivered service related information of at least the first UE, and results of checking whether at least one position within the coverage area satisfies the service quality requirement associated with the network delivered service.

Consider an example scenario, wherein a user A and a user B in a shopping mall (considered as the coverage area of the network node) are using a first UE and a second UE, for accessing the network delivered services such as an XR service, and a music streaming service, respectively. In such a scenario, the network node determines that an application being executed on the first UE to access the XR service requires more radio resources than an application being executed on the second UE to access the music streaming service. Therefore, the network node identifies a position B within the coverage area/shopping mall for the first UE in order to improve access to the XR service.

Upon identifying the position B within the coverage area, the network node determines whether the network quality information for the identified position B satisfies the service quality requirement associated with the network delivered service. In an example herein, consider that the position B satisfies the service quality requirement associated with the network delivered service. In such a scenario, the network node identifies position information for the network quality related recommendation. In some examples, the position information may include information about the position B. In some examples, the position information may include information about a direction and optionally, a distance to reach the position B within the coverage area. For instance, the position information may indicate that the UE has to move in the shopping mall 300 meters north to access the XR service.

At step 206, the method 200 comprises providing at least to the first UE, the network quality related recommendation for accessing the network delivered service. Thus, the network quality related recommendation may aid the first UE to move to a new position within the coverage area, at which the first UE may access the network delivered service with improved signal strength (reduced path loss), and performance and/or by meeting/satisfying the service quality requirement associated with the network delivered service.

In some embodiments, the step of providing to at least the first UE, the network quality related recommendation for accessing the network delivered service may comprise recommending information related to the position through one or more of: an application being executed on the first UE, and a short messaging service, SMS. In some examples, the application being executed on the first UE may pull the network quality related recommendation from the network node.

The network quality related recommendation may be presented to the user of the first UE in a form of text, icons, audio, and so on. Examples of presenting the network quality related recommendation in the form of text may include one or more of: “move into the shopping mall 300 meters north to use an XR application”, “move to other side of a road, to move the UE away from a blocking object in the signal path, to use an XR application”, or the like.

In some examples, the step of providing to at least the first UE, the network quality related recommendation for accessing the network delivered service may comprise determining whether the first UE has been subscribed for receiving the network quality related recommendation comprising information related to the position. When it has been determined that the first UE has been subscribed for receiving the recommendation, the method may comprise recommending to at least the first UE, the network quality related recommendation for accessing the network delivered service.

For example, if the first UE has been subscribed for receiving the network quality related recommendation, the network node may provide the first UE with the network quality related recommendation comprising information about the position within the coverage area and/or the direction and optionally the distance to move within the coverage area. If the first UE has not been subscribed for receiving the network quality related recommendation, the network node may notify the first UE that the network quality related recommendation may be available. However, the network quality related recommendation may be unlocked to the first UE only after subscribing for receiving the network quality related recommendation.

Further, at least the first UE may be subscribed for different types of network quality related recommendations. In some examples, at least the first UE may be subscribed for the network quality related recommendation to improve performance while accessing an XR service. In some other examples, at least the first UE may be subscribed for the network quality related recommendation to improve signal strength, so that reduced path loss may allow a battery of the first UE to last longer before recharging is required.

In some examples, the network node may inform application infrastructure providers (for example, application developers, and application configuration providers rather than the users of the application) about application coverage to perform suitable actions. For example, the network node may inform an application infrastructure provider to place artefacts of location based games in the position(s) specified in the network quality related recommendation.

FIG. 3 is a flowchart illustrating example method steps performed by the network node to determine the network quality related recommendation at least for the first UE.

At step 204a, the method comprises determining the position within the coverage area at least for the first UE. The position may be a spot or region within the coverage area.

In some embodiments, the step of determining the position may comprise obtaining network delivered service related information from at least the first UE within the coverage area. In some examples, the network delivered service related information may comprise one or more of: at least one application being executed on the first UE and radio resources required for the at least one application being executed on the first UE.

Based on the obtained network delivered service related information, the method may comprise at least one position within the area for the network quality related recommendation. The method may comprise obtaining the network quality information for the identified at least one position. Upon obtaining the network quality information, the method may comprise determining whether the network quality information for the identified at least one position satisfies the service quality requirement associated with the network delivered service. When it has been determined that the network quality information for the at least one identified position satisfies the service quality requirement associated with the network delivered service, the method may comprise determining the identified position as the network quality related recommendation for the first UE.

At step 204b, the method comprises determining a direction and optionally a distance to move within the coverage area at least for the first UE. As would be understood, in some examples, both steps 204a and 204b may be performed. In some other examples, either step 204a or step 204b may be performed.

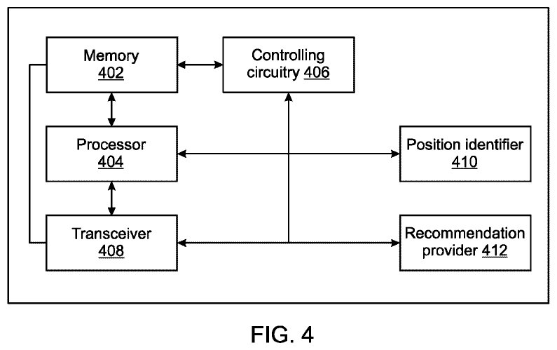

FIG. 4 is an example schematic diagram showing an apparatus 104. The apparatus 104 may e.g. be comprised in a network node. The apparatus 104 is capable of improving access to a network delivered service and may be configured to cause performance of the method 200 for improving access to the network delivered service.

In some other examples, the network node 104 may be a non-real time Radio Network, RAN, Intelligent controller, RIC, executing an R-app. In some other examples, the network node 104 may be a near real-time RIC in an Open RAN context. In some other examples, the network node 104 may include a node deployed in a computer cloud.

More generally, the network node 104 may represent any suitable device (or group of devices) capable, configured, arranged, and/or operable to enable and/or provide the at least one of the plurality of UEs 102a-102n with access to the wireless communication system.

According to at least some embodiments of the present invention, the apparatus 104 in FIG. 4 comprises one or more modules. These modules may e.g. be a memory 402, a processor 404, a controlling circuitry 406, a transceiver 408, a position identifier 410, and a recommendation provider 412. The controlling circuitry 406, may in some embodiments be adapted to control the above mentioned modules.

In some embodiments, at least some of the above modules may be present in different network nodes. For example, some of the modules may be present in a first network node which may be the DU of the RAN or the DU network node. The first network node is capable of transmitting the indication to the one or more second nodes, i.e., RUs, may comprise means arranged to perform the method 200 for improving access to the network delivered service.

In other embodiments, at least some of the above modules may be present in a second network node in the form of a radio unit, RU, of a RAN or the RU of a network node. The RU may comprise means arranged to perform the method 200 for improving access to the network delivered service.

In some embodiments, at least some of the above modules may be present in a cloud for execution of the method 200.

The memory 402, the processor 404, the transceiver 408, the position identifier 410, and the recommendation provider 412 as well as the controlling circuitry 406, may be operatively connected to each other.

The controlling circuitry 406 may be adapted to control the steps as executed by the network node. For example, the controlling circuitry 406 may be adapted to improve access to the network delivered service (as described above in conjunction with the method 200 and FIG. 2).

The transceiver 408 may be adapted to obtain network quality information for a coverage area comprising locations of the plurality of UEs.

The position identifier 410 may be adapted to determine, based on the network quality information, at least for the first UE among the plurality of UEs, a network quality related recommendation comprising information relating to a position within the coverage area for which the network quality information satisfies a service quality requirement associated with the network delivered service. In some examples, the network quality related recommendation may comprise the position within the coverage area at least for the first UE and/or a direction and optionally distance to move within the coverage area at least for the first UE.

The recommendation provider 412 may be adapted to provide at least to the first UE through the transceiver 408, the network quality related recommendation for accessing the network delivered service.

The processor 404 may be adapted to capture signal quality while providing the network delivered service to the plurality of UEs. In some examples, the signal quality may be used for determining the network quality information.

Further, the memory 402 is adapted to store the signal quality, the network quality information, the network quality related recommendation, and so on.

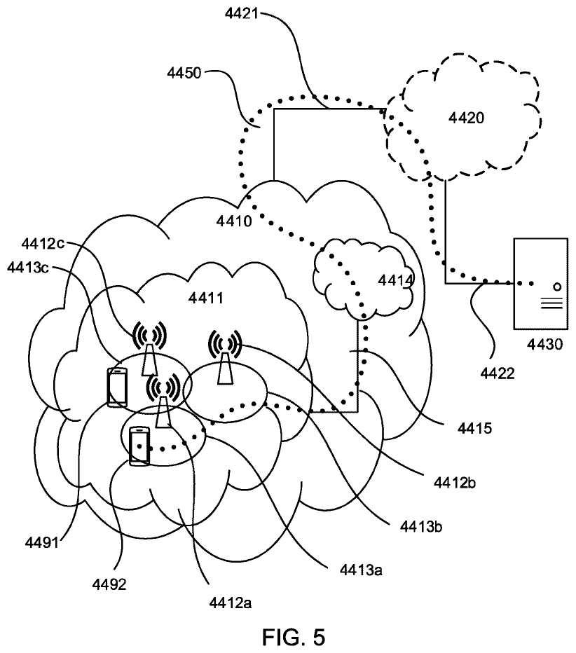

FIG. 5 is a block diagram of a telecommunication network connected via an intermediate network to a host computer according to some embodiments. With reference to FIG. 5, in accordance with an embodiment, a communication system includes telecommunication network 4410, such as a 3GPP-type cellular network, which comprises access network 4411, such as a radio access network, and core network 4414. Access network 4411 comprises a plurality of base stations 4412a, 4412b, 4412c, such as NBs, eNBs, gNBs or other types of wireless access points, each defining a corresponding coverage area 4413a, 4413b, 4413c. Each base station 4412a, 4412b, 4412c is connectable to core network 4414 over a wired or wireless connection 4415. A first UE 4491 located in coverage area 4413c is configured to wirelessly connect to, or be paged by, the corresponding base station 4412c. A second UE 4492 in coverage area 4413a is wirelessly connectable to the corresponding base station 4412a. While a plurality of UEs 4491, 4492 are illustrated in this example, the disclosed embodiments are equally applicable to a situation where a sole UE is in the coverage area or where a sole UE is connecting to the corresponding base station 4412.

Telecommunication network 4410 is itself connected to host computer 4430, which may be embodied in the hardware and/or software of a standalone server, a cloud-implemented server, a distributed server or as processing resources in a server farm. Host computer 4430 may be under the ownership or control of a service provider, or may be operated by the service provider or on behalf of the service provider. Connections 4421 and 4422 between telecommunication network 4410 and host computer 4430 may extend directly from core network 4414 to host computer 4430 or may go via an optional intermediate network 4420. Intermediate network 4420 may be one of, or a combination of more than one of, a public, private or hosted network; intermediate network 4420, if any, may be a backbone network or the Internet; in particular, intermediate network 4420 may comprise two or more sub-networks (not shown).

The communication system of FIG. 5 as a whole enables connectivity between the connected UEs 4491, 4492 and host computer 4430. The connectivity may be described as an over-the-top, OTT connection 4450. Host computer 4430 and the connected UEs 4491, 4492 are configured to communicate data and/or signaling via OTT connection 4450, using access network 4411, core network 4414, any intermediate network 4420 and possible further infrastructure (not shown) as intermediaries. OTT connection 4450 may be transparent in the sense that the participating communication devices through which OTT connection 4450 passes are unaware of routing of uplink and downlink communications. For example, base station 4412 may not or need not be informed about the past routing of an incoming downlink communication with data originating from host computer 4430 to be forwarded (e.g., handed over) to a connected UE 4491. Similarly, base station 4412 need not be aware of the future routing of an outgoing uplink communication originating from the UE 4491 towards the host computer 4430.

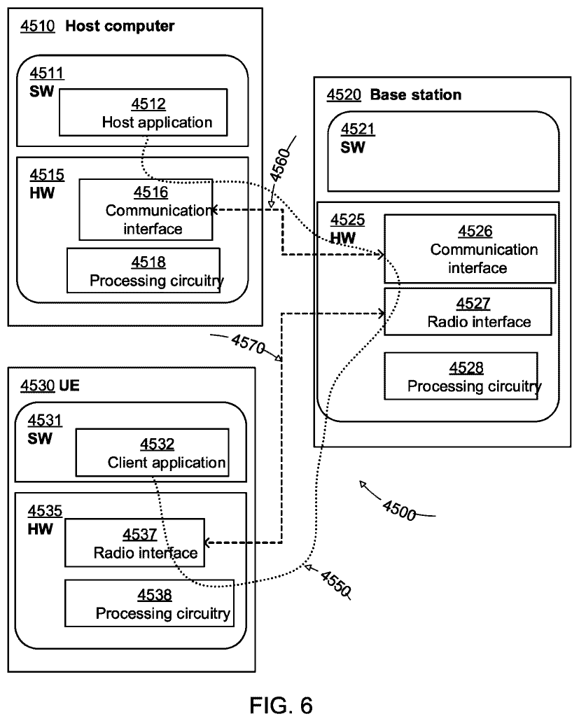

FIG. 6 is a block diagram of a host computer communicating via a base station with a user equipment over a partially wireless connection. The base station may be distributed into different physical or virtual nodes. Further, in an open RAN (e.g., as specified by O-RAN Alliance), the different nodes may be provided by different vendors.

Example implementations, in accordance with an embodiment, of the UE, base station and host computer discussed in the preceding paragraphs will now be described with reference to FIG. 6. In communication system 4500, host computer 4510 comprises hardware 4515 including communication interface 4516 configured to set up and maintain a wired or wireless connection with an interface of a different communication device of communication system 4500. Host computer 4510 further comprises processing circuitry 4518, which may have storage and/or processing capabilities.

In particular, processing circuitry 4518 may comprise one or more programmable processors, application-specific integrated circuits, field programmable gate arrays or combinations of these (not shown) adapted to execute instructions. Host computer 4510 further comprises software 4511, which is stored in or accessible by host computer 4510 and executable by processing circuitry 4518. Software 4511 includes host application 4512. Host application 4512 may be operable to provide a service to a remote user, such as UE 4530 connecting via OTT connection 4550 terminating at UE 4530 and host computer 4510. In providing the service to the remote user, host application 4512 may provide user data which is transmitted using OTT connection 4550.

Communication system 4500 further includes base station 4520 provided in a telecommunication system and comprising hardware 4525 enabling it to communicate with host computer 4510 and with UE 4530. Hardware 4525 may include communication interface 4526 for setting up and maintaining a wired or wireless connection with an interface of a different communication device of communication system 4500, as well as radio interface 4527 for setting up and maintaining at least wireless connection 4570 with UE 4530 located in a coverage area (not shown in FIG. 5) served by base station 4520. Communication interface 4526 may be configured to facilitate connection 4560 to host computer 4510. Connection 4560 may be direct or it may pass through a core network (not shown in FIG. 6) of the telecommunication system and/or through one or more intermediate networks outside the telecommunication system. In the embodiment shown, hardware 4525 of base station 4520 further includes processing circuitry 4528, which may comprise one or more programmable processors, application-specific integrated circuits, field programmable gate arrays or combinations of these (not shown) adapted to execute instructions. Base station 4520 further has software 4521 stored internally or accessible via an external connection.

Communication system 4500 further includes UE 4530 already referred to. Its hardware 4535 may include radio interface 4537 configured to set up and maintain wireless connection 4570 with a base station serving a coverage area in which UE 4530 is currently located. Hardware 4535 of UE 4530 further includes processing circuitry 4538, which may comprise one or more programmable processors, application-specific integrated circuits, field programmable gate arrays or combinations of these (not shown) adapted to execute instructions. UE 4530 further comprises software 4531, which is stored in or accessible by UE 4530 and executable by processing circuitry 4538. Software 4531 includes client application 4532. Client application 4532 may be operable to provide a service to a human or non-human user via UE 4530, with the support of host computer 4510. In host computer 4510, an executing host application 4512 may communicate with the executing client application 4532 via OTT connection 4550 terminating at UE 4530 and host computer 4510. In providing the service to the user, client application 4532 may receive request data from host application 4512 and provide user data in response to the request data. OTT connection 4550 may transfer both the request data and the user data. Client application 4532 may interact with the user to generate the user data that it provides.

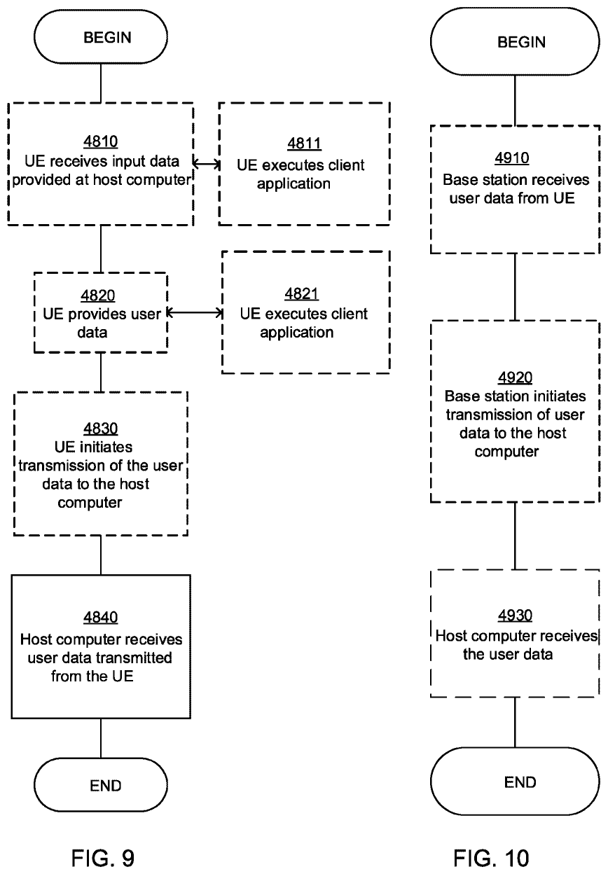

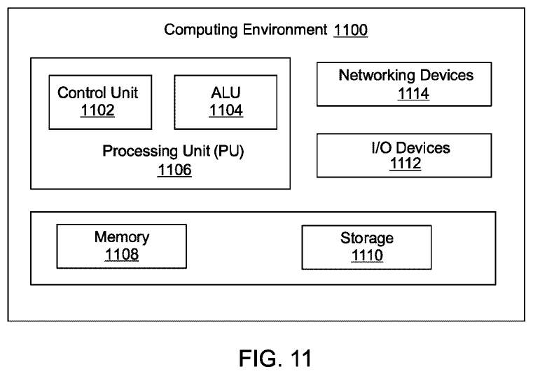

It is noted that host computer 4510, base station 4520 and UE 4530 illustrated in FIG. 9 may be similar or identical to host computer 4430, one of base stations 4412a, 4412b, 4412c and one of UEs 4491, 4492 respectively. This is to say, the inner workings of these entities may be as shown in FIG. 11 and independently, the surrounding network topology may be that of FIG. 6.

In FIG. 6, OTT connection 4550 has been drawn abstractly to illustrate the communication between host computer 4510 and UE 4530 via base station 4520, without explicit reference to any intermediary devices and the precise routing of messages via these devices. Network infrastructure may determine the routing, which it may be configured to hide from UE 4530 or from the service provider operating host computer 4510, or both. While OTT connection 4550 is active, the network infrastructure may further take decisions by which it dynamically changes the routing (e.g., on the basis of load balancing consideration or reconfiguration of the network).

Wireless connection 4570 between UE 4530 and base station 4520 is in accordance with the teachings of the embodiments described throughout this disclosure. One or more of the various embodiments may improve the performance of OTT services provided to UE 4530 using OTT connection 4550, in which wireless connection 4570 forms the last segment. More precisely, the teachings of these embodiments may improve the random access speed and/or reduce random access failure rates and thereby provide benefits such as faster and/or more reliable random access.

A measurement procedure may be provided for the purpose of monitoring data rate, latency and other factors on which the one or more embodiments improve. There may further be an optional network functionality for reconfiguring OTT connection 4550 between host computer 4510 and UE 4530, in response to variations in the measurement results. The measurement procedure and/or the network functionality for reconfiguring OTT connection 4550 may be implemented in software 4511 and hardware 4515 of host computer 4510 or in software 4531 and hardware 4535 of UE 4530, or both. In embodiments, sensors (not shown) may be deployed in or in association with communication devices through which OTT connection 4550 passes; the sensors may participate in the measurement procedure by supplying values of the monitored quantities exemplified above, or supplying values of other physical quantities from which software 4511, 4531 may compute or estimate the monitored quantities. The reconfiguring of OTT connection 4550 may include message format, retransmission settings, preferred routing etc.; the reconfiguring need not affect base station 4520, and it may be unknown or imperceptible to base station 4520. Such procedures and functionalities may be known and practiced in the art. In certain embodiments, measurements may involve proprietary UE signaling facilitating host computer 4510's measurements of throughput, propagation times, latency and the like. The measurements may be implemented in that software 4511 and 4531 causes messages to be transmitted, in particular empty or ‘dummy’ messages, using OTT connection 4550 while it monitors propagation times, errors or the like.

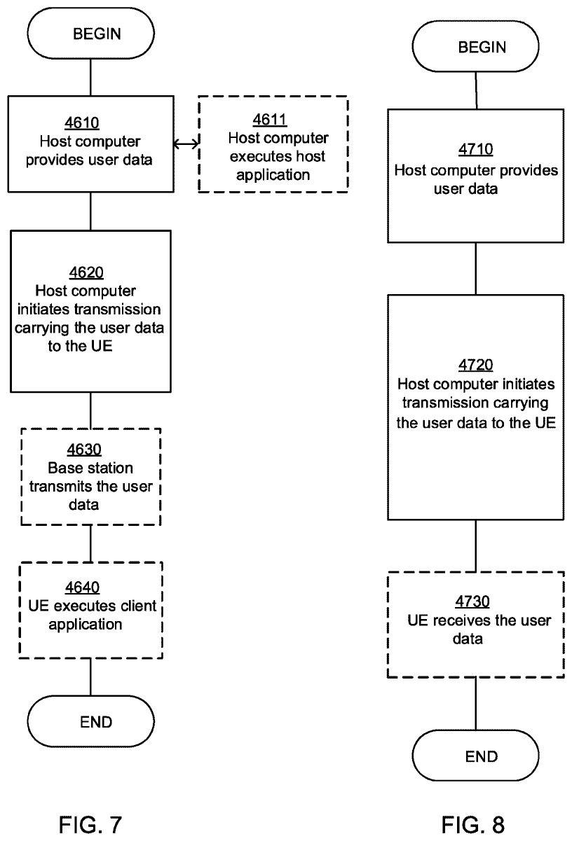

FIG. 7 is a block diagram of methods implemented in a communication system including a host computer, a base station, and a user equipment according to some embodiments. For simplicity of the present disclosure, only drawing references to FIG. 7 will be included in this section. In step 4610, the host computer provides user data. In substep 4611 (which may be optional) of step 4610, the host computer provides the user data by executing a host application. In step 4620, the host computer initiates a transmission carrying the user data to the UE. In step 4630 (which may be optional), the base station transmits to the UE the user data which was carried in the transmission that the host computer initiated, in accordance with the teachings of the embodiments described throughout this disclosure. In step 4640 (which may also be optional), the UE executes a client application associated with the host application executed by the host computer.

FIG. 8 is a block diagram of methods implemented in a communication system including a host computer, a base station, and a user equipment according to some embodiments. For simplicity of the present disclosure, only drawing references to FIG. 8 will be included in this section. In step 4710 of the method, the host computer provides user data. In an optional substep (not shown) the host computer provides the user data by executing a host application. In step 4720, the host computer initiates a transmission carrying the user data to the UE. The transmission may pass via the base station, in accordance with the teachings of the embodiments described throughout this disclosure. In step 4730 (which may be optional), the UE receives the user data carried in the transmission.

FIG. 9 is a block diagram of methods implemented in a communication system including a host computer, a base station, and a user equipment according to some embodiments. For simplicity of the present disclosure, only drawing references to FIG. 9 will be included in this section. In step 4810 (which may be optional), the UE receives input data provided by the host computer. Additionally or alternatively, in step 4820, the UE provides user data. In substep 4821 (which may be optional) of step 4820, the UE provides the user data by executing a client application. In substep 4811 (which may be optional) of step 4810, the UE executes a client application, which provides the user data in reaction to the received input data provided by the host computer. In providing the user data, the executed client application may further consider user input received from the user. Regardless of the specific manner in which the user data was provided, the UE initiates, in substep 4830 (which may be optional), transmission of the user data to the host computer. In step 4840 of the method, the host computer receives the user data transmitted from the UE, in accordance with the teachings of the embodiments described throughout this disclosure.

FIG. 10 is a block diagram of methods implemented in a communication system including a host computer, a base station, and a user equipment according to some embodiments. FIG. 10 is a flowchart illustrating a method implemented in a communication system, in accordance with one embodiment. The communication system includes a host computer, a base station and a UE. For simplicity of the present disclosure, only drawing references to FIG. 10 will be included in this section. In step 4910 (which may be optional), in accordance with the teachings of the embodiments described throughout this disclosure, the base station receives user data from the UE. In step 4920 (which may be optional), the base station initiates transmission of the received user data to the host computer. In step 4930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors, DSPs, special-purpose digital logic, and the like. The processing circuitry may be configured to execute program code stored in memory, which may include one or several types of memory such as read-only memory (ROM), random-access memory, RAM, cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

FIG. 11 illustrates an example computing environment 1100 implementing a method and the network node, as described in FIG. 2. As depicted in FIG. 11, the computing environment 1100 comprises at least one data processing module 1106 that is equipped with a control module 1102 and an Arithmetic Logic Unit (ALU) 1104, a plurality of networking devices 1108 and a plurality Input output, I/O devices 1110, a memory 1112, a storage 1114. The data processing module 1106 may be responsible for implementing the method described in FIG. 3. For example, the data processing module 1106 may in some embodiments be equivalent to the processor of the network node described above in conjunction with the FIG. 4. The data processing module 1106 is capable of executing software instructions stored in memory 1112. The data processing module 1106 receives commands from the control module 1102 in order to perform its processing. Further, any logical and arithmetic operations involved in the execution of the instructions are computed with the help of the ALU 1104.

The computer program is loadable into the data processing module 1106, which may, for example, be comprised in an electronic apparatus (such as a network node). When loaded into the data processing module 1106, the computer program may be stored in the memory 1112 associated with or comprised in the data processing module 1106. According to some embodiments, the computer program may, when loaded into and run by the data processing module 1106, cause execution of method steps according to, for example, any of the method illustrated in FIG. 2 or otherwise described herein.

The overall computing environment 1100 may be composed of multiple homogeneous and/or heterogeneous cores, multiple CPUs of different kinds, special media and other accelerators. Further, the plurality of data processing modules 1106 may be located on a single chip or over multiple chips.

The algorithm comprising of instructions and codes required for the implementation are stored in either the memory 1112 or the storage 1114 or both. At the time of execution, the instructions may be fetched from the corresponding memory 1112 and/or storage 1114, and executed by the data processing module 1106.

In case of any hardware implementations various networking devices 1108 or external I/O devices 1110 may be connected to the computing environment to support the implementation through the networking devices 1108 and the I/O devices 1110.

The embodiments disclosed herein can be implemented through at least one software program running on at least one hardware device and performing network management functions to control the elements. The elements shown in FIG. 11 include blocks which can be at least one of a hardware device, or a combination of hardware device and software module.

1. A method for improving access to a network delivered service, the method being performed by a radio access network, RAN, node comprising one or more network nodes, the method comprising:
obtaining network quality information for a coverage area comprising locations of a plurality of UEs;
determining based on the network quality information, at least for a first UE, a network quality related recommendation comprising information relating to a position within the coverage area for which the network quality information satisfies a service quality requirement associated with the network delivered service; and
providing at least to the first UE, the network quality related recommendation for accessing the network delivered service.

2. The method according to claim 1, wherein determining the network quality related recommendation at least for the first UE comprises:
determining the position within the coverage area at least for the first UE; and/or
determining a direction and optionally a distance to move within the coverage area at least for the first UE.

3. The method according to claim 1, wherein obtaining the network quality information comprises:
determining whether a recommendation request message is received from one or more of: at least the first UE, and an application being executed on the first UE for accessing the network delivered service; and
when it has been determined that the recommendation request message is received, obtaining the network quality information.

4. The method according to claim 1, wherein obtaining the network quality information comprises:
retrieving, from a database or from a model, signal quality associated with the plurality of UEs for the coverage area.

5. The method according to claim 1, wherein the network quality information comprises one or more of:
radio coverage characteristics of the network node;
performance characteristics of connection between the network node;
propagation properties of a radio channel established between the network node and the plurality of UEs; and
one or more scheduling schemes related to the network delivered service to the plurality of UEs.

6. The method according to claim 1, wherein determining the network quality related recommendation comprising information relating to the position within the coverage area comprises:
obtaining network delivered service related information from at least the first UE within the coverage area;
identifying at least one position within the coverage area for the network quality related recommendation based on the network delivered service related information;
obtaining the network quality information for the identified at least one position;
determining whether the network quality information for the identified at least one position satisfies the service quality requirement associated with the network delivered service; and
when it has been determined that the network quality information for the at least one identified position satisfies the service quality requirement associated with the network delivered service, identifying position information for the network quality related recommendation.

7. The method according to claim 6, wherein the network delivered service related information comprises one or more of:
at least one application being executed on the first UE; and
radio resources required for the at least one application being executed on the first UE (102a).

8. The method according to claim 1, wherein providing to at least the first UE the network quality related recommendation for accessing the network delivered service comprises recommending information related to the position through one or more of:
an application being executed on the first UE; and
a short messaging service, SMS.

9. The method according to claim 1, wherein providing to at least the first UE the network quality related recommendation for accessing the network delivered service comprises:
determining whether the first UE has been subscribed for receiving the network quality related recommendation comprising information related to the position; and
when it has been determined that the first UE has been subscribed for receiving the recommendation, recommending to at least the first UE, the network quality related recommendation for accessing the network delivered service.

10. The method according to claim 1, wherein the network delivered service is a subscription based service comprising one or more of: a data service, a voice service, a multimedia broadcast multicast service, MBMS, and over-the-top, OTT service.

11. An apparatus of a radio access network, RAN, node for improved access to a network delivered service, the RAN node comprising one or more network nodes, the apparatus comprising a controlling circuitry configured to:
obtain network quality information for a coverage area comprising locations of a plurality of UEs;
determine based on the network quality information at least for a first UE, a network quality related recommendation comprising information relating to a position within the coverage area for which the network quality information satisfies a service quality requirement associated with the network delivered service; and
provide at least to the first UE, the network quality related recommendation for accessing the network delivered service.

12. The apparatus according to claim 11, wherein the controlling circuitry is configured to determine the network quality related recommendation at least for the first UE by:
determination of the position within the coverage area at least for the first UE; and/or
determination of a direction and optionally a distance to move within the coverage area at least for the first UE.

13. The apparatus according to claim 11, wherein the controlling circuitry is configured to obtain the network quality information by:
determination of whether a recommendation request message is received from one or more of: at least the first UE, and an application being executed on the first UE for accessing the network delivered service; and
obtainment of the network quality information when the recommendation request message is received.

14. The apparatus according to claim 11, wherein the controlling circuitry is configured to obtain the network quality information by:
retrievement of signal quality associated with the plurality of UEs for the coverage area from a database or from a model.

15. The apparatus according to claim 11, wherein the network quality information comprises one or more of:
radio coverage characteristics of the network node;
performance characteristics of the network node;
propagation properties of a radio channel established between the network node and the plurality of UEs; and
one or more scheduling schemes related to the network delivered service to the plurality of UEs.

16. The apparatus according to claim 11, wherein the controlling circuitry is configured to determine the network quality related recommendation comprising information relating to the position within the coverage area by:
obtainment of network delivered service related information from at least the first UE within the coverage area;
identification of at least one position within the coverage area for the network quality related recommendation based on the network delivered service related information;
obtainment of the network quality information for the identified at least one position;
determination of whether the network quality information for the identified at least one position satisfies the service quality requirement associated with the network delivered service; and
identification of position information for the network quality recommendation when the network quality information for the identified at least one position satisfies the service quality requirement associated with the network delivered service.

17. (canceled)

18. The apparatus according to claim 11, wherein the controlling circuitry is configured to provide to at least the first UE the network quality related recommendation through one or more of:
an application being executed on the first UE; and
a short messaging service, SMS.

19. The apparatus according to claim 11, wherein the controlling circuitry is configured to provide to at least the first UE the network quality related recommendation for accessing the network delivered service by:
determination of whether the first UE has been subscribed for receiving the network quality related recommendation comprising information related to the position; and
recommendation of the network quality to at least the first UE when the first UE has subscribed for receiving the recommendation.

20. The apparatus according to claim 11, wherein the network delivered service is a subscription based service comprising one or more of: a data service, a voice service, a multimedia broadcast multicast service, MBMS, and over-the-top, OTT service.

21. (canceled)

22. A computer program product comprising a non-transitory computer readable medium, having thereon a computer program comprising program instructions, the computer program is loadable into a data processing unit and configured to cause execution of the method according to claim 1 when the computer program is run by the data processing unit.
